(19) United States
(12) Patent Application Publication
(10) Pub. No.: US 2008/0060574 A1
(43) Pub. Date: Mar. 13, 2008

(54) Powder coating spraying device

(75) Inventors: Abdel N. Bacchus, Richmond Hill, NY (US); Thomas Gardega, Conway, SC (US)

Correspondence Address: DILWORTH & BARRESE, LLP, 333 EARLE OVINGTON BLVD., SUITE 702, UNIONDALE, NY, 11553, US

(73) Assignee: XIOM CORPORATION, West Babylon, NY (US)

(21) Appl. No.: 11/900,820

(22) Filed: Sep. 13, 2007

Related U.S. Application Data
(60) Provisional application No. 60/844,198, filed on Sep. 13, 2006.

(51) Int. Cl. B05B 7/14

(52) U.S. Cl. 118/312

(57) ABSTRACT

A thermal spray device for applying powder and polymer coatings, to large areas by means of a staged double or triple Venturi oriented at the distal end to produce a compression wave is described. The spray patterns produced by the nozzles can range from about three inches to about nine inches. The gun is designed so that the front-end nozzles are interchangeable with other front-end nozzles so as to allow for quick changes between nozzles designed to cover different coverage areas. The lightweight compact design allows for comfort and high portability.

### CROSS-REFERENCE TO RELATED APPLICATIONS

This application claims priority to U.S. provisional application Ser. No. 60/844,198, filed Sep. 13, 2006, which is herein incorporated by reference.

### FIELD OF THE INVENTION

The powder-coating gun of the present invention can be used in a variety of fields where spraying plastic powder coating is desired. The powder coating gun is designed to use liquid, gel or gaseous fuels such as propane or butane. The design of the gun enables the spray produced by the gun to cover both large and small areas, mostly due to its modular nozzle design. Being compact and lightweight, any powder coater will be able to control the gun and spray material for much longer periods of time than when using other powder spray guns. In addition, the time required to complete a job will most often be greatly reduced due to the wider spray pattern.

### BACKGROUND OF THE INVENTION

Powder coating is a method of applying a coating onto a substrate in the form of a heat-treated powder. Traditional spray guns used to spray powder compositions utilize an oven to melt and cure the powder. As need for anti-corrosion, anti microbial, anti-fouling, and electrically resistant versatile coatings increases, the need to apply them quickly and efficiently has become more and more critical. A fast way of applying these coatings to any surface without having to bake the part is needed. In part, combustion guns produced by Xiom™, Corp. are able to eliminate the need for oven-melting of the powder particles. This is achieved by melting the particles in mid air right before contact is made with the surface to be treated. The powders then cure almost instantly, providing a very durable coating.

These combustion guns can utilize compressed air to run a control console, powder feeder and the gun. These guns can also use Oxygen and Propane in order to create the flame, which is used to melt the powders. Flame temperatures ranging from 600 degrees F. to 1000 degrees F. melt the powders for application (depending on the material). This system reduces the time needed to thermally spray a surface/device and cure the sprayed coating by melting and curing the powder simultaneously. In other words, the hours needed to bake and cure the surface/device in a conventional powder coating system are no longer needed, saving time and money. In order to increase efficiency of the thermal spraying process, a gun capable of covering a larger area than currently available is in great demand.

### OBJECT OF THE INVENTION

The present invention is directed to a spray gun that enables powder coaters to spray much larger areas than currently available systems. The spray gun of the present invention uses of a planar powder nozzle and two planar flame nozzles to spread powder particles out into a fan like pattern, thus increasing its coverage area. The spray gun of the present invention is able to spray the same compositions used in currently available spray guns. Therefore, the time associated with coating an area is reduced since each pass of the spray gun covers a larger coverage area than currently available thermal spray guns. For example, the currently available thermal spray guns have a maximum spray width of about 3 inches, whereas the thermal spray gun of the present invention has a maximum spray width of about 9 inches or greater depending on the type of nozzle used. The spray gun of the present invention is also light and therefore easy to maneuver during spraying procedures.

As is evident from the discussion above, the thermal spray gun of the present invention solves many problems that exist with previous systems. The time to spray large and small surfaces is greatly reduced. The high portability allows the thermal spray gun to be used at almost any job site and in a more efficient manner. Finally, the thermal spray gun of the present invention does not only use compressed air but also takes air from the surrounding atmosphere and therefore no longer requires an oxygen tank, thus increasing the portability and reducing the weight of the total system.

### SUMMARY OF THE INVENTION

This present invention is directed to a portable, thermal spray gun that is able to produce a wider spray width than conventional guns available on the market today. This allows the gun to be used almost anywhere which makes it a very useful tool for any powder coater. Its lightweight, compact design, allows it to be taken to jobs which were once thought of as impossible to powder coat. For example, the thermal coating system of the present invention will allow for the coating of ships, rooms, airplanes, etc. without any disassembly. The wider spray pattern produced by the thermal spray gun of the present invention allows for fast application of various powder compositions thereby efficiently covering large surfaces. The only required inputs into this gun and system are air and fuel. The air can be obtained from the surrounding atmosphere either using or not using a Venturi system and the fuel used can be propane.

In one embodiment of the invention, the thermal spray coating device comprises a spray body having an axial conduit for passage there through of powdered coating material. The spray body may also be configured to have a handle for easy grip. Attached to the spray body are at least two flame nozzle bodies, each of which have at least one attaching means for attaching the flame nozzle bodies to the spray body. The flame nozzle bodies comprise at least one air compression blade having at least one conduit for passage of air there through that is configured so as to direct a flame away from the flame nozzle bodies to a desired compression angle formed between a powder stream from the spray body and the air compression blade itself. The air compression angle can vary from about 6 degrees to about 60 degrees.

The thermal spray coating device of the present invention also comprises at least one fuel blade having at least one conduit for passage of compressed gaseous combustible fuel that is attached to or near the flame nozzle bodies described above. Also attached to or near the flame nozzle bodies is at least one air injection blade having at least one conduit for passage of air. The air injection blade is configured to inject air into the flame produced by the flame nozzle bodies so as to aid in combustion of the fuel source and to cool off the flame so that it does not get too hot so as to burn, instead of melt, the composition being applied to the surface.

The thermal spray coating device is also equipped with at least one powder nozzle having an attaching means for attaching to the spray body and at least two powder jets, each of which have at least one conduit for the passage of air there through. The passage of air through the conduit of the powder nozzle impacts a powder stream produced from the spray body causing it to fan or spread out so as to produce a larger spray pattern than if the this was not used. The powder nozzle of the present invention further comprises at least two air blades having at least one conduit for the passage of air there through. Air passed through the conduits produces an air stream positioned between the powder coating stream from the spray body and the flame so as to prevent the powder coating from coming in direct contact with said flame. In other words, the stream of air allows the powder coating to come close enough to the flame to melt but not too close so as to burn.

The above described thermal spray device can be used with a variety of thermal spray composition and is further described in the drawings and description that follows.

### BRIEF DESCRIPTION OF THE DRAWINGS

FIG. 1 is a right view of the thermal spray device of the present invention.

FIG. 2 is a top view of the thermal spray device of the present invention.

FIG. 3 is a front view of the thermal spray gun of the present invention.

FIG. 4 shows the compression blade of the present invention.

FIG. 5 shows the fuel blade of the present invention.

FIG. 6 shows the powder nozzle of the present invention.

FIG. 7 shows a partially cut-away perspective view of the Fuel Delivery Barrel of the present invention.

FIG. 8 shows the Air Injection Blade of the present invention.

FIG. 9 shows the flame nozzle body of the present invention.

FIG. 10 shows the Venturi of the present invention.

### DETAILED DESCRIPTION OF THE INVENTION

The thermal spray device of the present invention is unlike any currently available thermal spray device available on the market today. The device of the present invention provides a thin, smooth thermal spray coating and produces spray patterns up to about 9 inches in width. This is double the width pattern of some thermal spray devices available on the market today. This larger spray pattern is accomplished without jeopardizing the quality of the coat being applied, and in fact, produces a superior coating in terms of texture and thickness.

The thermal spray device of the present invention unique design allows for the use of propane gas to fuel its flame. Since oxygen must be mixed with the propane for combustion, oxygen is taken directly from the surrounding air using the fuel blade of the present invention. The ability to siphon oxygen from the surrounding air saves on cost associated with compressed oxygen and reduces the overall weight of the system. In addition, since an oxygen tank is not needed, the gun is less expensive to produce and safer to use. The gun of the present invention utilizes several unique components. In order to siphon the right amount of oxygen needed to make the oxygen propane mixture rich enough for combustion, the gun can either use a conduit in the fuel blade to provide oxygen to combine with the fuel for combustion. To enhance the amount of oxygen in the fuel, the present invention may incorporate a Venturi system so as to siphon even more air from the surrounding area thereby making the fuel mixture even richer. In an alternative embodiment of the present invention the fuel blade can be equipped with a double or triple Venturi system.

The flame nozzle bodies are located at the front end of the thermal spray device of the present invention and are designed to allow the flame to stand proud from the nozzle, meaning it burns away from the nozzle. This design feature ensures that the device does not get hot and also keeps the flame from burning back into the system. As another safety feature, a double or triple Venturi systems allows for the flame to extinguish eliminating a flame burn back into the device. The propane/oxygen mixture will be rich enough for the propane to combust in the first and second stage of a double Venturi system. This protects against flashback.

Since different coating materials require different temperatures to melt the flame temperature is critical. Some materials melt at lower temperatures than others and thus having good flame control is a major issue. The pre-heating of substrate material is also a concern. In order to achieve the appropriate bond the surface of the substrate must be pre-heated. Depending on the size and thickness of some metallic substrates, the heat requirement will vary. The spraying of thick pieces of steel, for example, requires a large heat input due to the rapid heat dissipation through the material. Propane mixed with the right amount of oxygen can burn at 3500° F., which is much too high for the coating process and pre-heating. The optimum flame temperature range for applying the coating is 600°-1000° F. However pre-heating might require a slightly higher temperature. Since adding too much compressed air and atmospheric air can cool the flame temperature, the device includes an oxygen input port.

The inclusion of the oxygen port not only aids in achieving higher temperature but it also makes the device more portable. Since using only compressed air and atmospheric air to mix with the propane to enable combustion, the air compressor must be large enough to supply enough air for mixing with the propane and enough to cool the produced flame. By adding the oxygen port the coater only needs to add a small amount of oxygen gas into the device that will aid in the combustion. Thus, the compressed air can only be used for flame cooling. The coater's compressor would not need to be upgraded to a larger size if more air is needed.

The thermal spray device of the present invention utilizes a unique heating system to apply powder coating material onto a substrate. Since the device has the ability to spray a large area, a special heating source is required that would be able to uniformly heat and melt the powder throughout its full length. This heating system would also have to be able to preheat the substrate sufficiently in order for the coating to be able to have high bond strength. A unique heating nozzle was designed consisting of several jetted air blades and a similar fuel blade to accomplish this task.

The heating system of the present invention consists of the flame nozzle body, fuel delivery barrel, air compression blade, propane blade, and air injection blade. The spray gun will require a pair of the specially designed flame nozzles in order for optimum performance. The flame nozzle body connects the other parts to form the flame nozzle. Each flame nozzle consists of three inputs, two for air and one for propane. The fuel delivery barrel delivers the propane to the flame nozzle while it mixes it with the siphoned air from the Venturi system. If oxygen is inputted through the oxygen port then the oxygen, propane, and the siphoned air mixes along the length of the barrel.

The flame nozzle body is angled at about 22 degrees but can cover a range of about 6 degrees to about 60 degrees. This angle creates a compression plane (with the assistance of the compression blade) when two flame nozzles are put side by side. This compression plane allows for the energy from the flame to be transferred to the powder particles in order to melt the particles mid flight prior to impact with the substrate.

The fuel blade propels the propane at a velocity greater than the rate of combustion. This also prevents the flame from burning back into the nozzle and also allows it to stand off of the fuel blade. By having the flame stand off of the fuel blade it prevents the flame heat from being transferred to the blade itself and further being transferred to other parts of the gun. To enable the flame to stand off the blade and to obtain the required velocity greater than the rate of combustion, the outlets on the blade are milled at about 0.03125 inches in diameter but can range from 0.015 inches to about 0.100 inches. To enable the flame to cover the 9-inch pattern of the powder nozzle may contain about 24 outlets drilled into the blade to create about 24 flame jets along its length. Although the outlets can be drilled straight into the blade, it is a preferred embodiment of the present invention to drill the outlets in the blade at about a 20-degree angle to allow the stream of propane to hit the surface of the flame nozzle body for dispersion. This creates a flame curtain that will heat the large powder pattern.

The air compression blade creates the compression plane as mentioned earlier. Since air contains 21% oxygen, the air compression blade supplies enough oxygen to the propane in order for it to combust. When two flame nozzles are put together the flame tends to wrap back due to a vacuum that is created by the compression plane. There are also about 24 outlets drilled at about 20 degrees into the air compression blade. The diameters of the outlets are about the same as those of the propane blade, namely about 0.03125 inches, but range from 0.015 inches to about 0.100 inches. The 24 or so outlets allow for the compression of the large flame curtain throughout its length.

An air injection blade is placed on each flame nozzle of the present invention to force the flame forward. The added air not only prevents the flame from wrapping back but also provides extra oxygen to the flame for complete combustion of the propane. The added air also cools down the temperature of the flame to the temperatures needed to melt the powder particles without burning. The air injection blade is also equipped with having about 24 outlets with about a 0.03125-inch diameter, also ranged from 0.015 inches to about 0.100 inches, and drilled at 20-degree angle into it in order to uniformly cool and direct the flame curtain forward.

Although a matrix of drilled out holes are used on the blades of the nozzles, less than about 24 holes can be used and in fact a single slot could also be used. A single slot or less than about 24 outlets with the same total area as the 24 drilled out jets discussed above would ultimately result in the same outcome. However, for ease of machining, the holes were easier to maintain and machine than the slots. Although the slots require a much higher tolerance than the machined outlets, they are still an option.

The thermal spray device of the present invention is also unique in its modular front end. The powder nozzles of the present invention are easy to remove and replace with a new nozzle or different nozzles for different spray patterns. It's crucial to be able to change between nozzles quickly without difficulty in order to make the thermal spray device easy to use. For this reason alone, the thermal spray device of the present invention is designed with a modular front end. Nozzles that can be used in the thermal spray gun of the present invention can produce patterns that range from about 3 inches to about 9 inches depending on the job and its requirements.

The powder nozzle is itself unique. The powder nozzle uses a special air jet to fan out the powders to create the large spray patterns. This special air jet is enclosed within the powder nozzle, which is unlike any other spray gun. Enclosing the powders and Incorporating the air jets into the nozzle allows the powder particles to spread out uniformly and exit the nozzle in a large fan pattern. The enclosure of the powders within the nozzle aids in keeping the fan pattern stable and uniform and prevents the powders from deviating from their projected path.

The powder nozzle also includes its own pair of air blades. The air blades are situated at the distal end of the nozzle. The air blades aid in the acceleration of the powder as it exits the nozzle and it also cools the flame when the powder passes through it. Since the powders can fuel the flame and burn up the air provided by these air blades, protecting the powders from being burned while allowing enough heat through to melt the particles is a critical criterion to manage. This is done by the air compression blade in concert with the other components of the thermal spray device of the present invention. Each air blade of the present invention contains about 24 jets that are approximately about 0.015 inches to about 0.100 inches, preferably about 0.076 inches in diameter. This allows a larger volume of air to envelop the powders as they pass through the flame.

In order to make the gun as portable as possible, keeping the weight of the gun low was a critical aspect of the design. The object of the present invention is to maintain a light gun that is easy to use. The maximum weight of the thermal spray device of the present invention is about 6 lbs. This is considered being extremely light in comparison to other thermal spray devices available. In addition to reduced weight, it was also important to make the design of the device very simple so that the device can be maintained relatively easily. The simple, but unique design of the thermal spray device of the present invention decreases the chance of improperly installing components leading to failure.

As stated above, several of the components used in the thermal spray device of the present invention are unique in their own right. For example, the powder nozzle of the present invention is unique and novel in that it utilizes a coincident taper and flare, whereby the nozzle is flattened and flared so that the distal portion is a wide fan with a cross section area equal to that of its circular input. The nozzle also incorporates two impinging air jets set at about 22.5° but can be set at anywhere from about 8 degrees to about 60 degrees. This impingement is analogous to the fan spray pattern jets on a wet paint gun only that it is internally enclosed within the gun as opposed to externally directed. This makes this fan nozzle new and novel as the applicants are not aware of any other nozzle currently available either in wet paint, thermal spray, or powder coating spray apparatus.

The thermal spray device of the present invention may utilize a double or triple Venturi system to supply oxygen to the fuel for the combustion. An optional oxygen input port may also be used to import additional oxygen if needed. This unique combination produces an air mixture that is rich enough to combust propane when combined in the first stage if it is a double Venturi or in stage one and two if it's a triple Venturi in order to prevent flashback.

Finally, the various air blades used in the thermal spray device of the present invention in order to compress the flame and powder to about 20 degrees can also be used to cover a range of about 8 to about 60 degrees. It is believed that this unique air blade has never been used on any thermal spray equipment.

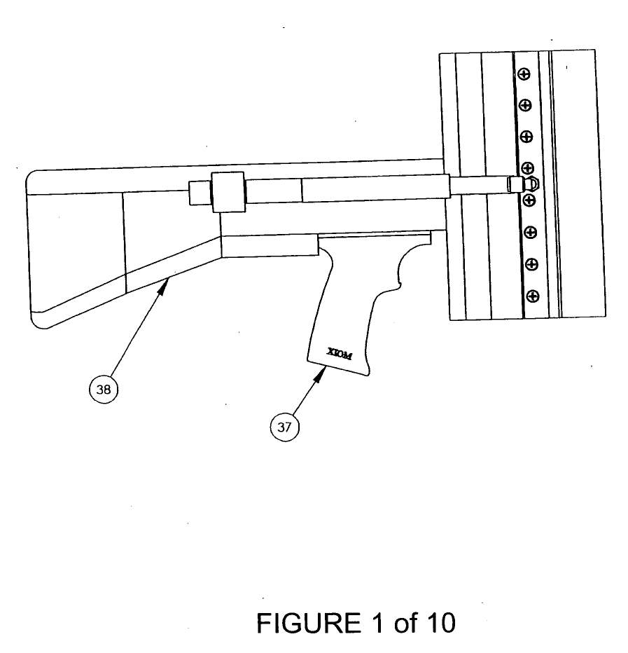

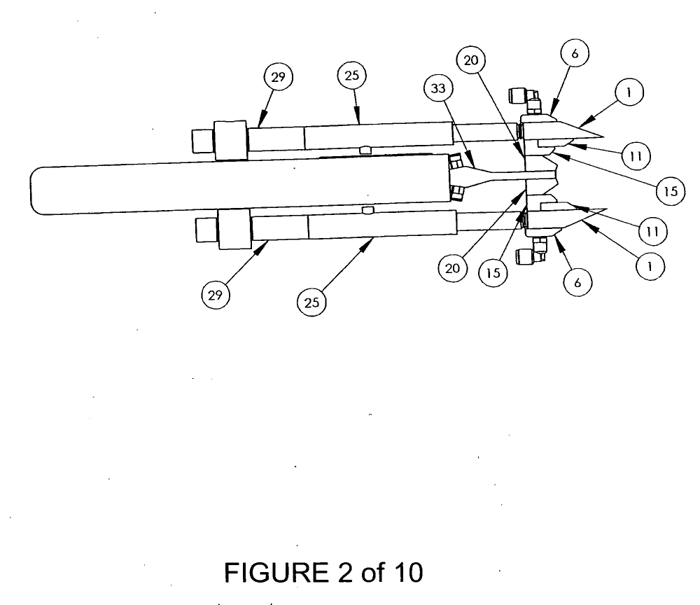

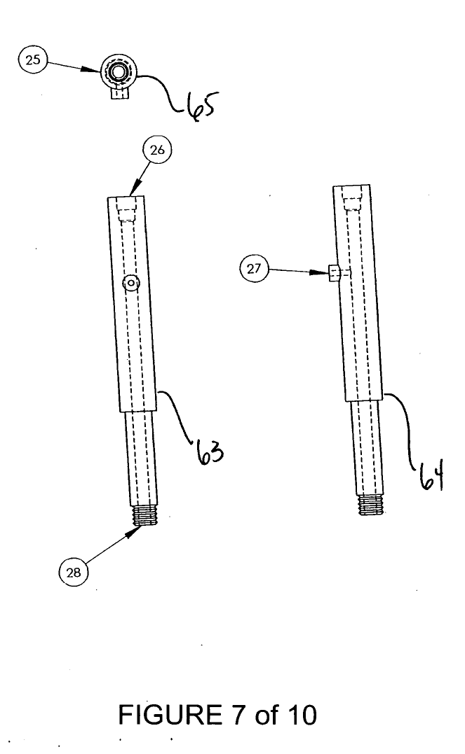

Referring now to the figures, FIG. 1 is a right view of the thermal spray device of the present invention. As shown in FIG. 1, the thermal spray device has two main body parts namely, the stock of the thermal spray device (38) and the handle (37). The handle is ergonomically designed to allow easy manipulation and maneuvering of the thermal spray device of the present invention. The additional components which when fully assembled are attached to the stock (38), are described in FIGS. 2-10.

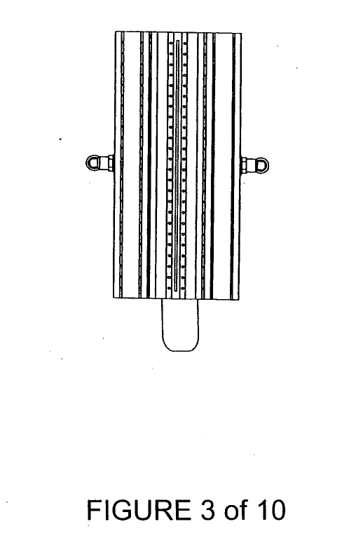

FIG. 2 shows a top view of the thermal spray device of the present invention. Form this view several of the components of the thermal spray device of the present invention is shown. As shown in FIG. 2, the front most portion of the FIG. 2 is the flame nozzle body (1) which is flanked by the fuel blade (11) on one side and the compression blade (6) on the other side. To the rear of the fuel blade is the injection blade (15) flanked by the air blade (20). This arrangement of the front portion of the present invention provides a thermal spray device that produces a spray pattern as discussed above. Each of these components operate as described above and contribute to the wider overall spray pattern of the present invention. Starting in the front section of the thermal spray device and projecting to the rear of the device is the powder nozzle (33). On the outside of the thermal spray device shown is the fuel delivery barrel (25) that is in direct contact with the Venturi system (29) to provide additional oxygen to the combustible fuel source in the fuel delivery barrel (25). FIG. 3 shows a prospective front view of the thermal spray gun of the present invention.

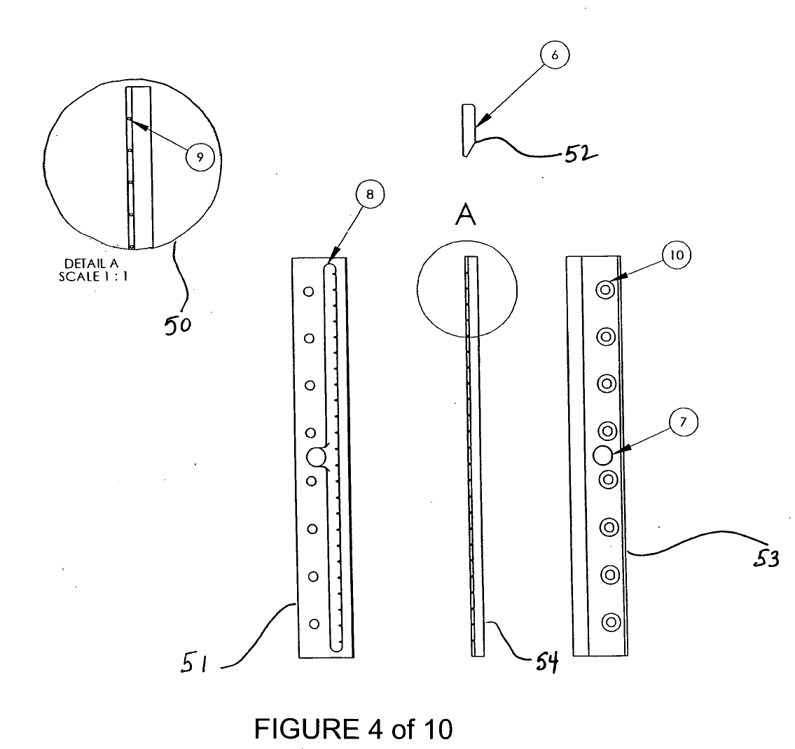

The air compression blade of the present invention is shown in several prospective view in FIG. 4. One view provided is a top prospective view (52) of the air compression blade (6). A right prospective view (51) and a left prospective view (53) is also shown. The right prospective view (51) further shows the details of the air chamber (8) of one embodiment of the present invention. The left prospective view (53) shows an air inlet (7) and mounting holes (10) for attaching the air compression blade (6) to the gun stock of the present invention. The front view (54) is shown in greater detail in insert (50) that is a detail cut a way that shows the nozzle jets (9) of the present invention.

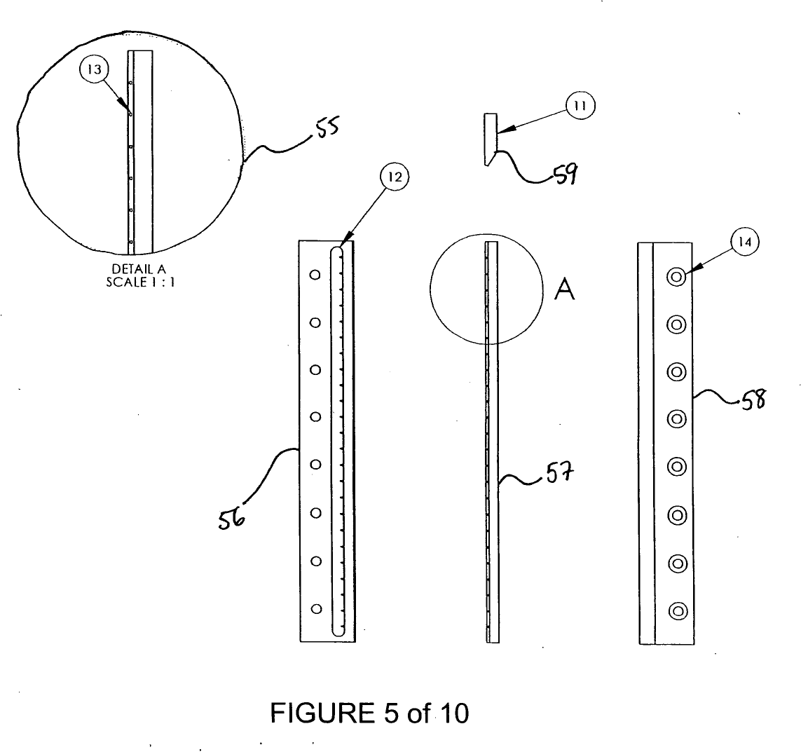

Similarly, FIG. 5 shows the fuel blade of the present invention. As with the compression blade shown in FIG. 4, several different views are provided of the fuel blade of the present invention. The similarity between I the compression blade is clear form comparing FIGS. 4 and 5, with the main difference being that the right prospective view (56) and the left prospective view (58) does not have an air inlet as in the air compression blade shown in FIG. 4. The top view (59) of the fuel blade (11) is shown in further detail in the right prospective view (56) where the propane chamber (12) is detailed. The left prospective view (54) of the fuel blade, much like the compression blade shown in FIG. 4, shows the mounting holes (14) of the fuel blade (11) which are used to mount the fuel blade to the gun body as shown in FIG. 1. The front view (57) is shown in greater detail (55) in the insert detailing the nozzle jets (13) of the fuel blade (11), used as described above.

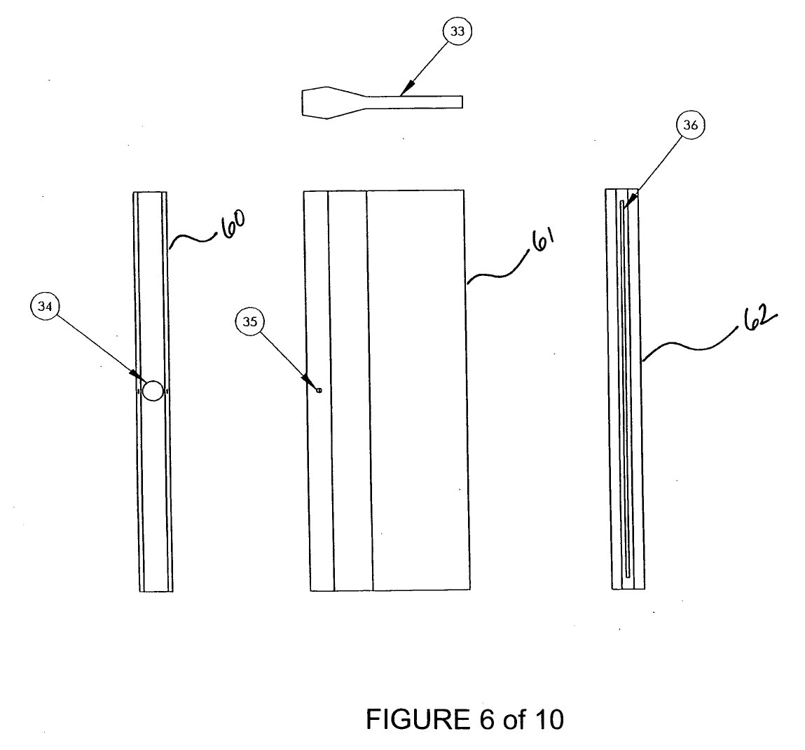

FIG. 6 shows the powder nozzle of the present invention. The powder nozzle (33) of the present invention is shown in several views. The rear view (60) of the powder nozzle is shows the powder inlet (34) while the right prospective view (61) shows the air jet (35) of the powder nozzle of the present invention. Finally, the front view (62) of the powder nozzle (33) of the present invention is shown having a nozzle outlet (36) in the form of a channel. This would also attach the gun body and provide powder coating material that will melt and disperse on the surface to be coated.

As stated above, compressed fuel, such as hydrogen, propane or other compressed hydrocarbon fuel sources, is used to produce the flame in order to melt the powder coating projected out of the powder nozzle of the present invention. The fuel delivery barrel (25), delivers fuel to be burned. A front prospective view (65) shows the fuel delivery barrel (25). The right prospective view (63) shows a threaded fuel outlet (28) at one end of the fuel delivery barrel (25) for connecting to the flame nozzle body and a propane inlet (26) at the other end used to connect to the Venturi. In the embodiments where a Venturi is not used, the propane inlet (26) will connect directly to the fuel source. In the right prospective view of the fuel delivery barrel (64) an oxygen port (27) is shown which can be connected to an additional oxygen source if necessary.

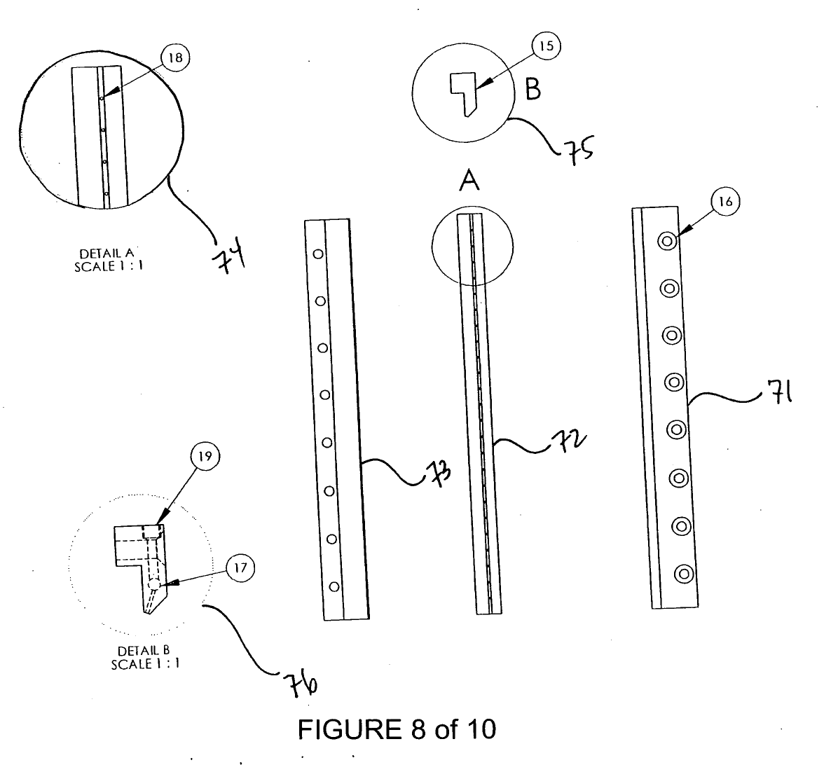

As discussed above, also part of the thermal spray device of the present invention is the air injection blade (15) which is shown in several different views in FIG. 8. The top view (75) of the air injection blade (15) is shown along with the left prospective view (73), the right prospective view (71), and the front view (72). As with the other parts of the present invention, mounting holes (16) are shown in the right prospective view (71) of the air injection blade (15). These mounting holes are used to attach the air injection blade to the flame nozzle body of the present invention. A detailed cut away prospective (76) further details the placement of the air inlet (19) and the air chamber (17) of the injection blade (15) of the present invention. A detailed view of the nozzle jets (18) is shown in the front detail view (74) of the air injection blade (15).

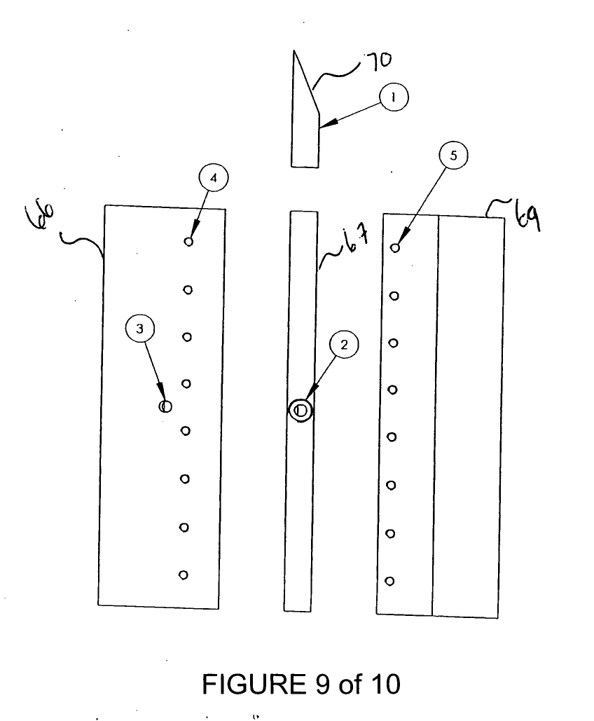

FIG. 9 shows the flame nozzle body of the present invention that all of the components of the present invention are attached is shown in several different views. A top view (70) of the flame nozzle body is shown (1). In addition a right prospective view (66), a left prospective view (69) and a front view (67) of the Flame nozzle body (1) of the present invention is also shown in FIG. 9. A fuel outlet (3) is shown in the right prospective view (66) where the fuel inlet (2) is shown in the front view (67) of the flame nozzle body (1) of the present invention. As shown in FIG. 2, the flame nozzle body is attached to the compression blade at one end. This attachment is done using the compression blade mounting holes (5) shown in the right prospective view (69) of the present invention.

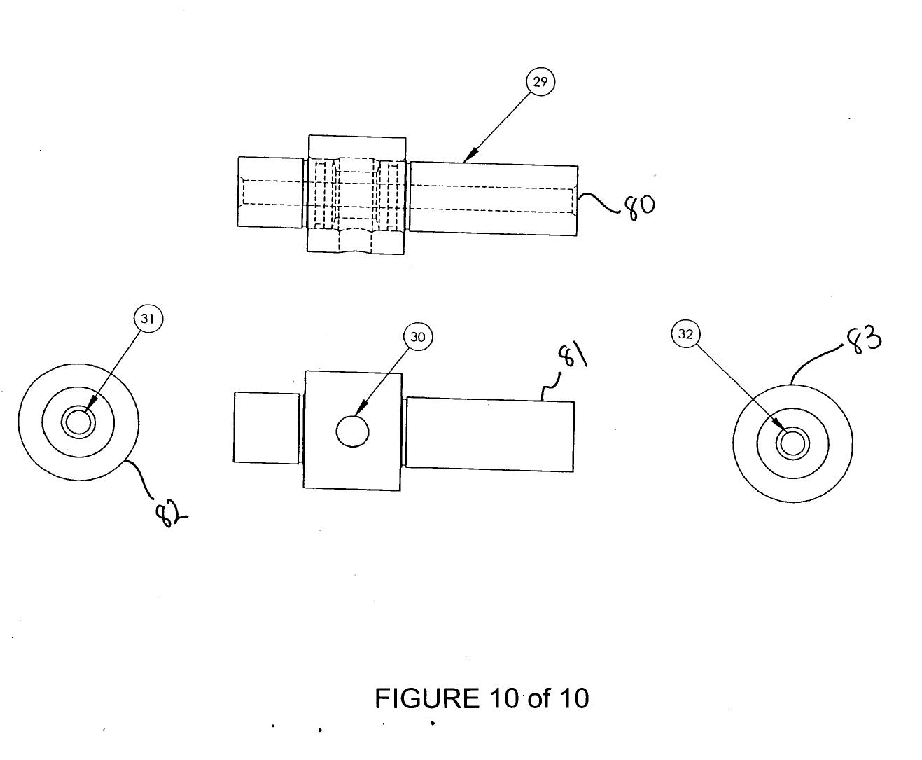

As stated above, a Venturi system can be used to siphon additional air (oxygen) into the flame for enhanced combustion of the compressed fuel source. FIG. 10 shows several views of a Venturi system that can be used with the present invention. A partial cut away top view (80), a right prospective view (81), a front prospective view (31) and a rear prospective view (83) of the Venturi system is shown in FIG. 10. The front view (80) further shows the air siphon inlet used to siphon air into the Venturi system so it can be combined with the compressed fuel source for better combustion and for cooling the flame. The outlet (32) of the Venturi system is shown in the rear prospective (83) of the Venturi system. The Venturi system is connected to the compressed fuel source, i.e. propane fuel barrel, at the compressed fuel inlet (30). This assures that the extra oxygen obtained by using the Venturi system is properly funneled to the compressed fuel source so as to enrich the fuel with oxygen for better combustion.

The above described figures are provided to provide further structure and detail to the detailed description of the present invention but are not meant to be the only possible configuration of the present invention. In other words, while the above description and figures contain many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A thermal spray coating device comprising:
a) a spray body having an axial conduit for passage there through of powdered coating material, and a handle;
b) at least two flame nozzle bodies, each of said flame nozzle bodies having at least one attaching means for attaching said flame nozzle bodies to said spray body, each of said flame nozzle bodies comprising at least one air compression blade having at least one conduit for passage of air there through, said air compression blade configured so as to direct a flame away from said flame nozzle bodies to a desired compression angle formed between a powder stream from said spray body and said air compression blade;
at least one fuel blade having at least one conduit for passage of compressed gaseous combustible fuel in communication with said flame nozzle bodies;
at least one air injection blade having at least one conduit for passage of air, said air injection blade configured to inject air into said flame for combustion and cooling of said flame in communication with said flame nozzle bodies; and
at least one powder nozzle having an attaching means for attaching to said spray body, said powder nozzle having at least two powder jets each of which having a conduit for the passage of air there through whereby air passed through said conduit of said powder nozzle impacts a powder stream produced from said spray body thereby spreading out said powder stream;
said powder nozzle further comprising at least two air blades having at least one conduit for the passage of air there through whereby air passed through said conduits produces an air stream positioned between said powder stream from said spray body and said flame so as to prevent said powder coating from coming in direct contact with said flame.

2. The thermal spray coating device of claim 1 further comprising a fuel barrel attached to said fuel blade and configured so as to accept a supply feed of a compressed gaseous combustible fuel.

3. The thermal spray coating device of claim 2 further comprising at least a single Venturi air system attached to said fuel barrel so as to provide an additional air source to be combined with said compressed gaseous combustible fuel.

4. The thermal spray coating device of claim 3 wherein a double Venturi air system is attached to said fuel barrel.

5. The thermal spray coating device of claim 3 wherein a triple Venturi air system is attached to said fuel barrel.

6. The thermal spray coating device of claim 1 wherein the compressed gaseous combustible fuel is selected from the group consisting of propane, hydrogen gas, methane gas, ethane gas, natural gas, and mixture thereof.

7. The thermal spray coating device of claim 1 wherein said compression angle formed between said powder stream from said spray body and said air compression blade is between about 6 degrees to about 60 degrees.

8. The thermal spray coating device of claim 7 wherein compression angle formed between said powder stream from said spray body and said air compression blade is about 23 degrees.

9. The thermal spray coating device of claim 1 wherein said at least two powder jets of said powder nozzle have about 24 outlets drilled at about 20 degrees and have a diameter of about 0.015 inches to about 0.100 inches.

10. The thermal spray coating device of claim 9 wherein the diameter of said outlets are about 0.03125 inches in diameter.

11. The thermal spray coating device of claim 10 wherein said powder jets of said powder nozzle each contain about 24 outlets having a diameter of about 0.015 inches to about 0.100 inches.

12. The thermal spray coating device of claim 11 wherein the outlets of said powder nozzle have a diameter of about 0.076.
